(19) United States
(12) Patent Application Publication
(10) Pub. No.: US 2014/0339972 A1
(43) Pub. Date: Nov. 20, 2014

(54) FURNITURE UNIT

(71) Applicant: Juergen Fehre, Boebingen an der Rems (DE)

(72) Inventor: Juergen Fehre, Boebingen an der Rems (DE)

(73) Assignee: FEHRE DESIGN GMBH, Boebingen an der Rems (DE)

(21) Appl. No.: 14/241,858

(22) PCT Filed: Aug. 28, 2012
(86) PCT No.: PCT/EP2012/003610

§ 371 Date: Jul. 14, 2014

(30) Foreign Application Priority Data
Sep. 1, 2011 (DE) 10 2011 112 073.8

(51) Int. Cl. A47B 47/00; F16B 12/26; F16B 12/02

(52) U.S. Cl. CPC A47B 47/00; F16B 12/02; F16B 12/26
USPC 312/265.5

(57) ABSTRACT

The invention relates to a furniture unit (1) having a frame structure (2), which delimits a box-shaped receiving space (3). On at least one side (4), a partition frame (20) having a partition wall (19) is accommodated. The partition wall (19) can be locked and aligned by means of an adjustment unit (50).

The present invention relates to a furniture unit for a great variety of applications. The furniture unit is particularly preferably employed in kitchens. Use is also possible and preferred in rack and cabinet systems and in other modular furniture. A piece of furniture may consist of one single furniture unit or else of multiple, sectional furniture units, which in turn form a larger furniture unit.

Various break-down furniture units have been disclosed in the prior art which are used for house and office furniture, for shelf systems in sales facilities and the like. These furniture units require little space for transport in their disassembled state. They can then be reassembled on site. A number of tools are required as a rule.

The time required and the complexity in assembling restrict the options for using these kinds of systems particularly in the case of furniture body elements complex in design.

DE 101 27 311 B4 discloses a furniture body configured to be disassembled and suitable for nearly no-tools assembly.

It is the object of the present invention to develop the known system further in an advantageous way so as to provide for easier assembly and/or improved functionality.

This object is solved by furniture units according to the invention having the features of the claims 1 and 8. Advantageous specific embodiments of the invention are the subjects of the subclaims. Further advantages and features of the invention can be taken from the general description and the description of the exemplary embodiment.

An inventive furniture unit according to claim 1 comprises at least one frame body that defines a box-shaped accommodating space. On at least one side a partition frame having a partition panel is accommodated. The partition frame accommodates the partition panel so it can be locked and/or aligned by at least one adjusting unit.

The furniture unit according to the invention has many advantages since it ensures simplicity of structure and reliability of function.

Due to the partition frame accommodating the partition panel a rigid partition frame can be provided that withstands high loads. The adjusting unit locks the partition panel at the partition frame so as to prevent inadvertent removal of the partition panel. At the same time the adjusting unit can align the partition panel to thus even out in particular small and tiny deviations in the region of less than 1 mm.

Preferably the partition frame comprises a top and a bottom beam wherein the adjusting unit is placed between the partition frame and the top beam for locking. Basically it is also possible to insert the adjusting unit between a bottom beam and the partition frame for locking the partition panel at the partition frame.

The adjusting unit is in particular L-shaped and comprises in particular one long and preferably one short contacting leg for the partition frame.

Preferably one, and in particular the short one, of the contacting legs is provided with a pair of adjusting screws for aligning the partition panel in two different directions. In particular is one adjusting screw provided for diverting the action so that the screw is turned in one direction while alignment is effected in a direction transverse thereto.

Particularly preferably the adjusting screw acts on a split region of one and in particular the longer of the contacting legs for adjusting the height. For example when the screw is turned by the screw tip into a frusto-conical accommodation within the split region then such screwing in causes the split region to expand so as to result in an alignment transverse to the driving direction of the adjusting screw.

Preferably the adjusting unit comprises at least one spring arm for latching that in particular protrudes from the long contacting leg. When the adjusting unit has been pushed in the spring arm that in particular protrudes from the long contacting leg and forms an approximately V-shaped aperture toward the short contacting leg, ensures latching if there is free space above the spring arm for the spring arm to resiliently rise after being pushed in. This reliably prevents removal of the adjusting unit since an attempt at removal causes an end of the spring arm to bear against a wall of the notch.

For removal in turn, a finger of a hand or a tool such as a screwdriver can be inserted into the notch from the side to bend the resilient spring arm downwardly so that the adjusting unit can now be readily removed.

Therefore it is preferred for the spring arm to engage in a notch of the top beam in the mounted state.

In another configuration an inventive furniture unit according to claim 8 comprises at least one frame body that defines at least one box-shaped accommodating space. The frame body is supported on at least two cross bars wherein one of which serves as the top cross bar and another one, as the bottom cross bar. The top cross bar is joined to the bottom cross bar via at least one supporting section. At least one joint section is provided for joining at least one cross bar to at least one supporting section. The joint section comprises an angular head that enters into the cross bar in the mounted state.

This furniture unit according to the invention has considerable advantages since it allows and facilitates a nearly no-tools assembly of the entire furniture unit. These two cross bars together with the supporting sections form one base frame that can for example be fastened to the wall of a building. All the other components are attached to said base frame.

A simple connection is enabled at the cross bar due to connecting at least one supporting section via at least one joint section with at least one cross bar. The angular head of the joint section can be inserted through a hole in the cross bar so that the angular head is reliably retained at the cross bar.

Preferably at least one cross bar has at least one hole for receiving the angular head of the joint section. In particular is a plurality of evenly spaced holes provided in the cross bar. Particularly preferably both of the cross bars are identical in structure.

The joint section is preferably connected with the supporting section via at least one screw. Or else it is possible for the joint section to be connected with the supporting section via two or more screws. This type of joint requires just a screwdriver for connecting the supporting section with the cross bar via the joint section. A modular structure is possible where any desired dimensions can be realized according to the hole distances.

In other configurations it is also possible for the joint section to comprise at least one latch joint for connecting with the supporting section. This allows a structure that entirely dispenses with screws. The latch joint is inserted into a matching stop groove of the supporting section where it latches into the supporting section while the angular head of the joint section is retained in the hole of the cross bar. The result is a stable and firm structure that can be realized substantially without tools.

Further advantages and features of the present invention can be taken from the description of the exemplary embodiments, which will be discussed with reference to the following figures.

The figures show in:

FIG. 1 a partial view of a furniture unit according to the invention;

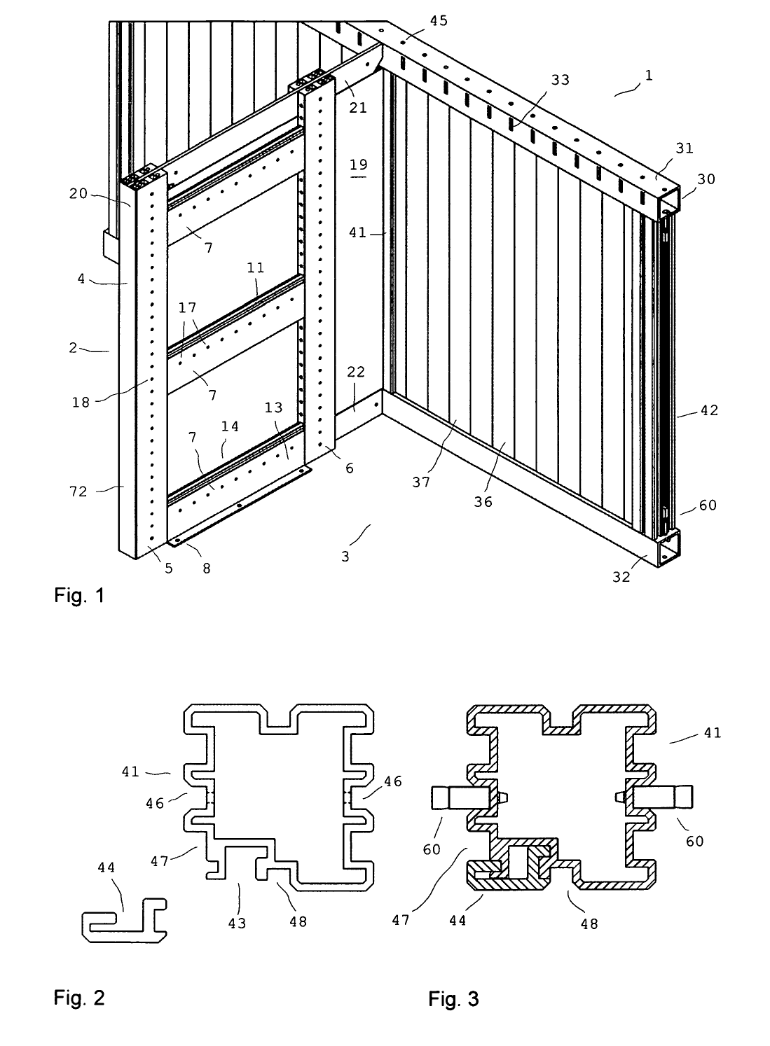

FIG. 2 a section of a supporting section with a separate closing section;

FIG. 3 a section of the functional section of FIG. 2 with the closing section mounted;

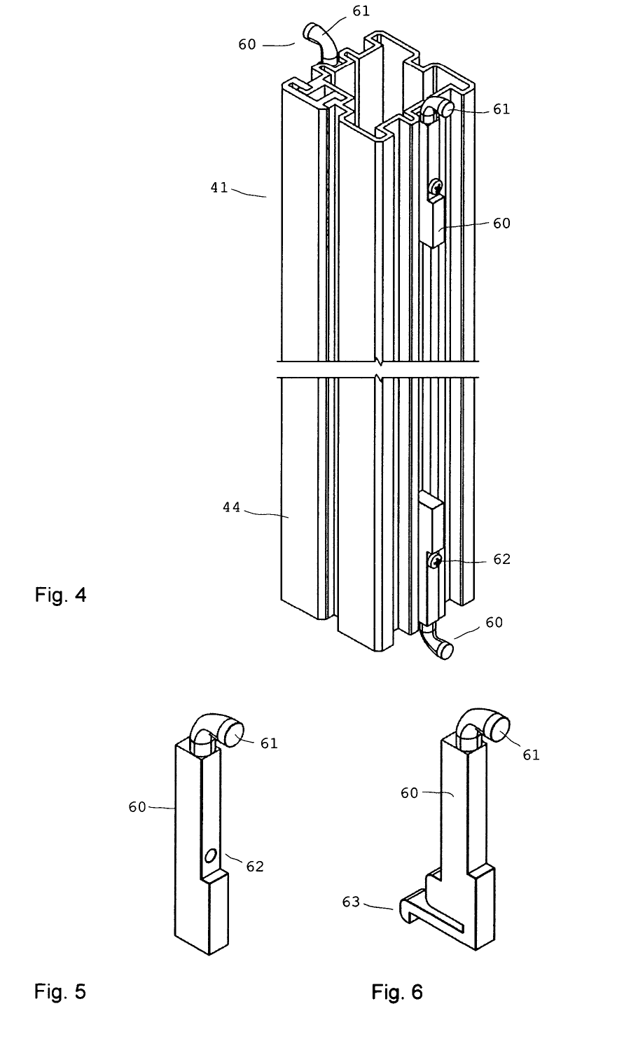

FIG. 4 a schematic, perspective view of a functional section with joint sections provided thereat;

FIG. 5 a joint section of FIG. 4;

FIG. 6 an alternative embodiment of the joint section of FIG. 5;

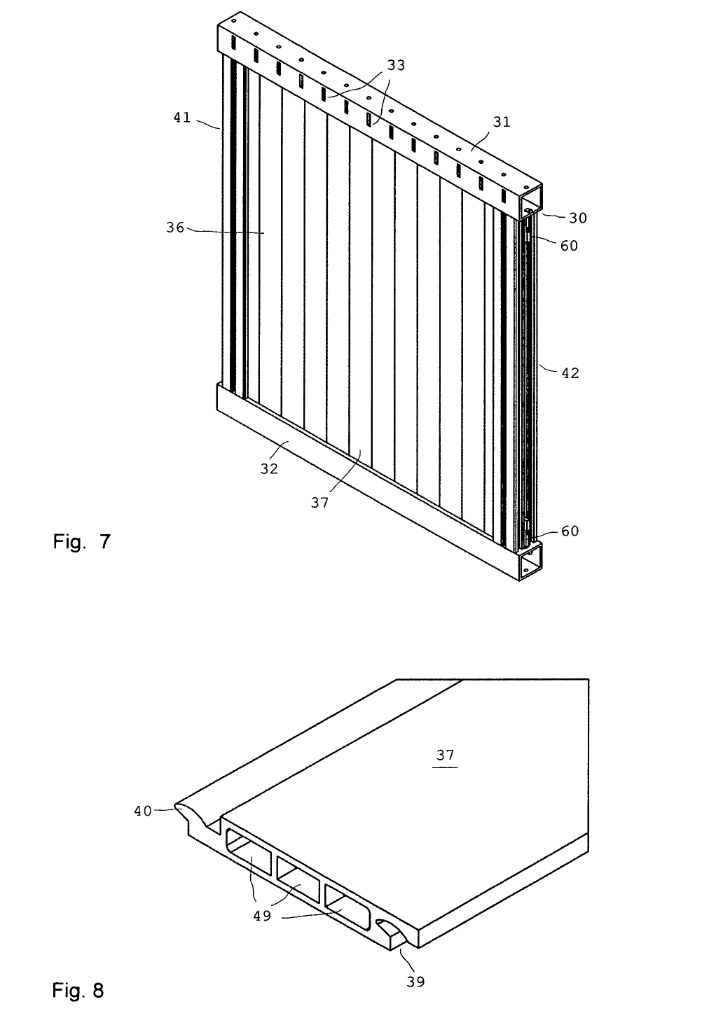

FIG. 7 a schematic, perspective view of a rear panel of the furniture unit of FIG. 1;

FIG. 8 a schematic, perspective view of a panel section of the rear panel of FIG. 7;

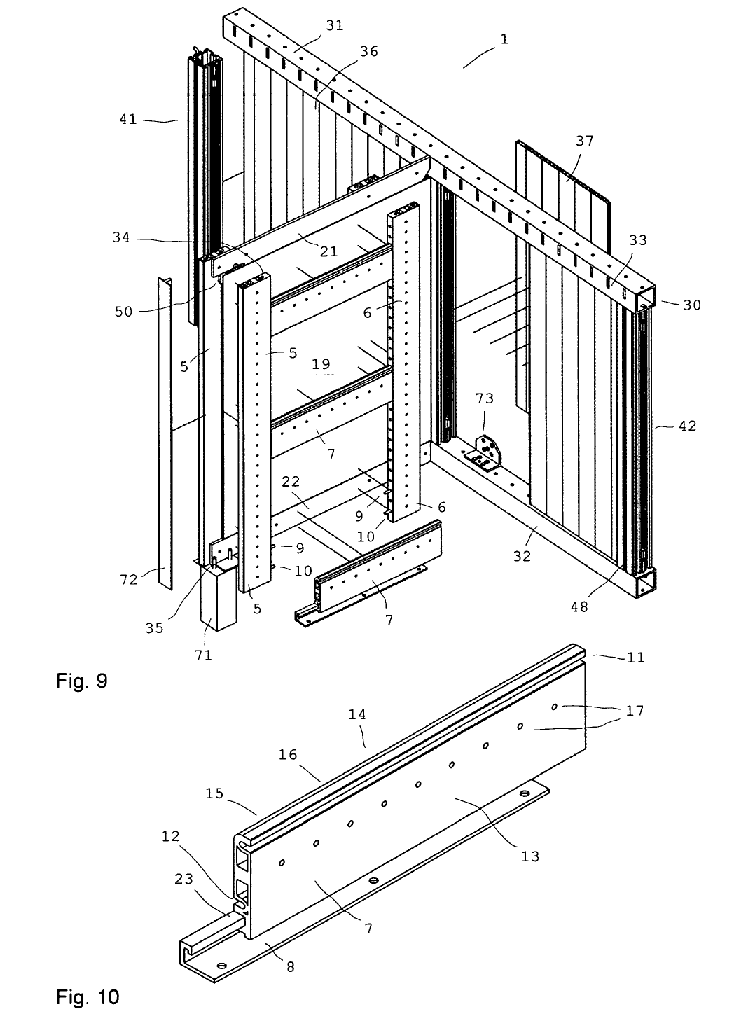

FIG. 9 a schematic, exploded view of part of a furniture unit according to the invention;

FIG. 10 an enlarged illustration of a fitting section;

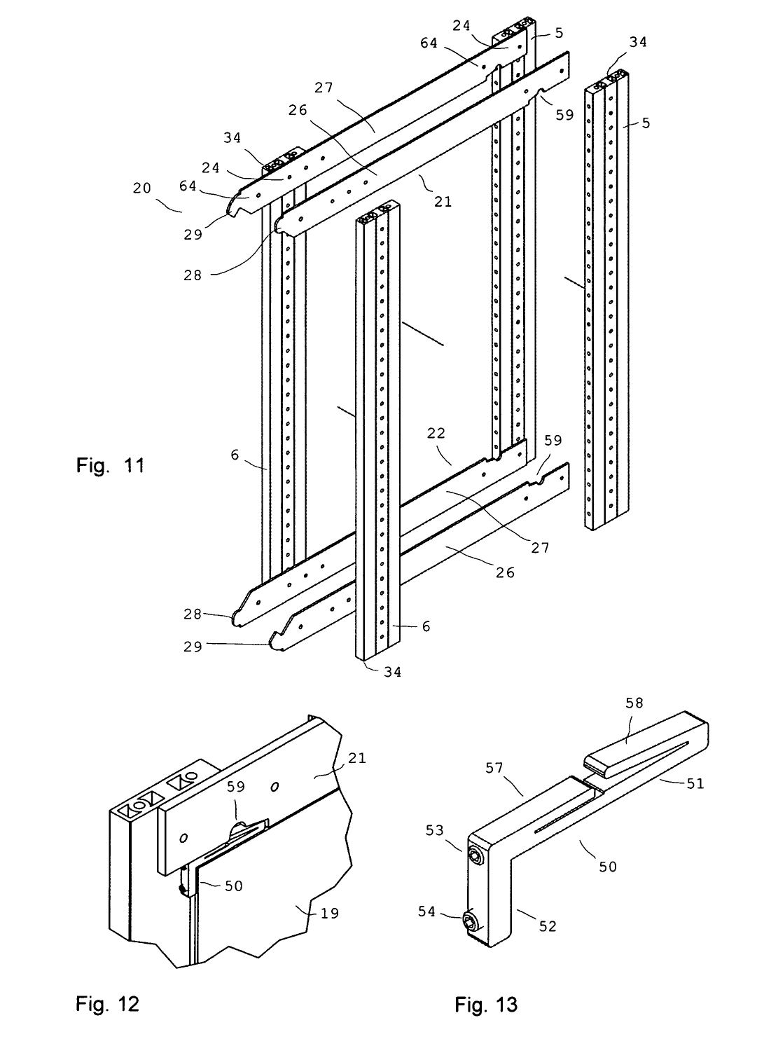

FIG. 11 another configuration of the partition frame of the furniture unit of FIG. 9;

FIG. 12 an enlarged illustration of a corner of the partition frame of FIG. 9;

FIG. 13 the adjusting unit for aligning the partition panel of FIG. 9;

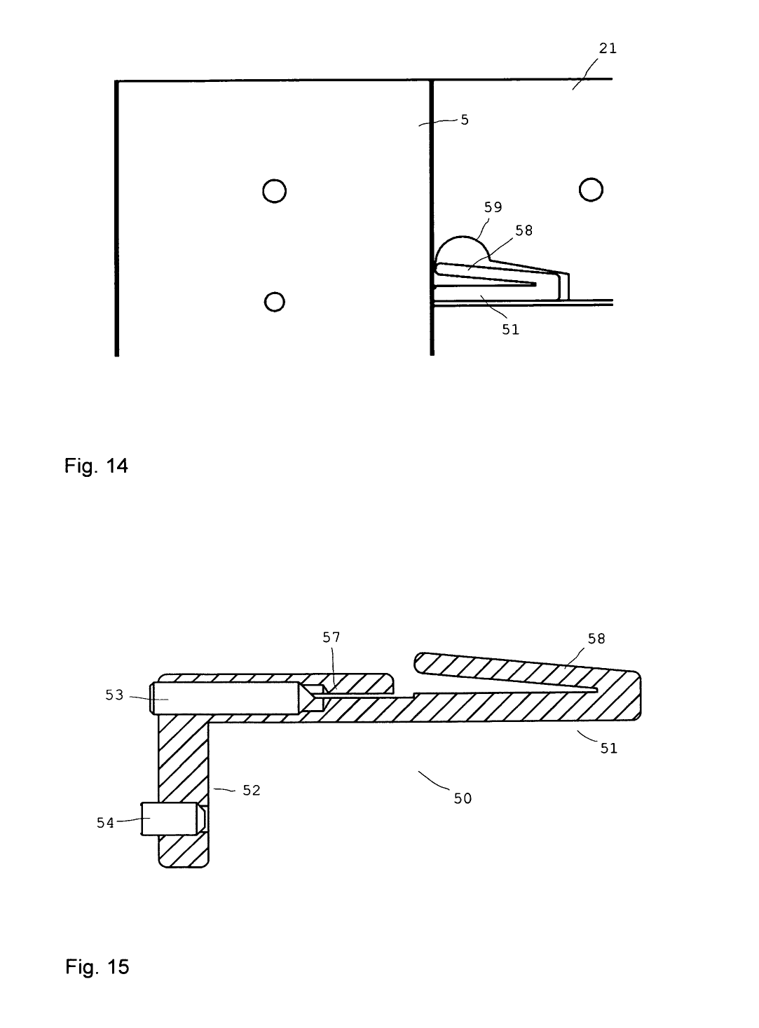

FIG. 14 the installing situation of the adjusting unit of FIG. 9;

FIG. 15 an enlarged cross section of the adjusting unit of FIG. 13;

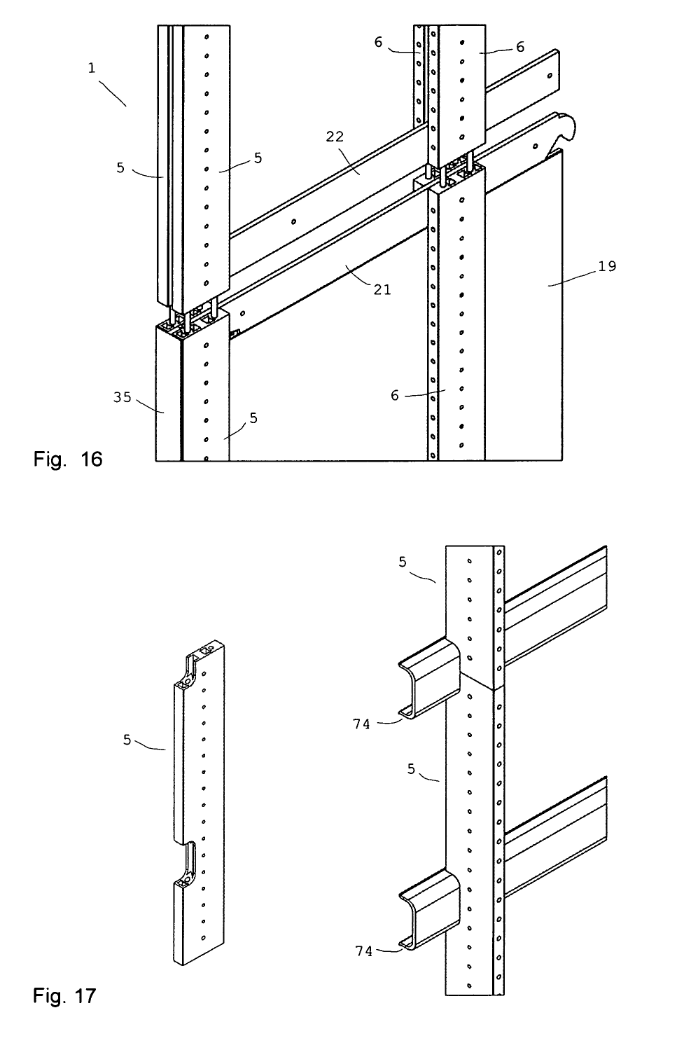

FIG. 16 two stacked frame bodies; and

FIG. 17 an alternative embodiment of a functional section and of two functional sections with a pulling device mounted.

With reference to the enclosed figures, exemplary embodiments of furniture units 1 according to the invention will be discussed below.

FIG. 1 shows a perspective representation of part of the furniture unit 1. The furniture unit shows a rear panel 36 that is modular in structure and includes single panel sections 37, which extend laterally between supporting sections 41 and 42 and in the height between a bottom cross bar 32 and a top cross bar 31. The panel sections 37 of the rear panel allow a modular structure and thus any desired width of the rear panel and thus of the furniture element, stepped in the widths of the panel sections 37.

The bottom cross bar 32 and the top cross bar 31 may for example be attached to a wall of a building, serving to support the entire furniture unit 1.

The top cross bar 31 comprises slots 33 for inserting a partition frame 20. To this end the partition frame 20 has an engaging lug 29, not shown in FIG. 1, at the top beam 21 the end of which is angular so that it latches into and is secured in the top cross bar 31.

The furniture unit 1 is provided with at least one frame body 2 that provides a box-shaped or square accommodating space 3 that is presently shown on the side in front of the partition frame 20. An accommodating space 3 is formed on the other side of the partition frame. The accommodating spaces 3 may serve to receive any desired furniture elements 8. The accommodating spaces 3 may for example be provided with drawers or electrical appliances or cabinet elements or the like.

The partition frame 20 comprises the top beam 21 and the bottom beam 22, and functional sections 5 and 6. Two functional sections 5 are provided as the front functional sections, receiving between them the top beam 21 in an upper region and the bottom beam 22 in a lower region. The two beams 21 and 22 and the functional sections are linked to one another in non-visible pivot points to form a four-bar mechanism.

The partition frame forms a side panel 4 of the frame body 2.

Three fitting sections 7 are disposed between the functional sections at different heights. Each of the fitting sections 7 comprises an inner longitudinal face 13 and an outer longitudinal face 14. The inner longitudinal face 13 is oriented toward the interior of the accommodating space 3, comprising a first groove 11 extending over the entire length of the fitting section 7.

Furthermore, holes 17 forming a row of holes are provided in the inner longitudinal face 13 of the fitting section 7. At the height of the holes 17 of the fitting section 7 there is also a hole 18 in the functional sections 5, 6. Preferably all the holes are spaced apart by specified and substantially equal distances.

The bottommost fitting section 7 shows a fitting as the furniture element 8 that is received in another groove 23 on the outer longitudinal face 14, not shown, of the fitting section 7. By means of the furniture element 8 that is presently formed as a bottom angle, further components such as shelves, drawer cabinets and the like can be attached to the furniture unit 1.

The partition panel frame 20 may comprise a partition panel 19 that may be made of standard materials. The partition panel 19 may for example be of glass and it may be transparent or opaque.

The top cross bar 31 and the bottom cross bar 32 are preferably identical in structure and may be positioned for example mirror-inverted. Both the cross bars may comprise top and bottom holes 45 disposed equidistantly in analogy to the slots 33. The holes 45 allow the mounting of different elements. For example joint sections 60 may be provided for joining the supporting sections 41, 42 to the cross bars 31, 32. The cross bars 31 and 32 and the supporting sections 41 and 42 form a base frame 30.

FIG. 2 shows a cross-section of a supporting section 41 with a closing section 44, not mounted. The supporting section 41 comprises various longitudinal grooves 46, 47, 43 and 48 etc. extending over the entire length of the supporting section 41 which is presently configured as an extruded hollow section.

The supporting section 41 preferably consists of a light metal such as aluminium or the like. Manufacturing from plastic or wood is likewise possible.

The side rabbet 47 may for example be provided for accommodating the rear panel 36 where a lateral end of a panel section 37 is pushed into the rabbet 47. Subsequently the rear panel is locked by attaching the closing section 44 so that the rear panel is securely received. This is the state shown in FIG. 3 where the closing section 44 has been attached to the supporting section 41.

FIG. 3 furthermore shows two joint sections 60 which are screwed to the supporting section 41 on both sides for joining the supporting section 41 to the top cross bar 31 or the bottom cross bar 32.

The front groove 48 may serve to receive the partition panel 19 which may furthermore be additionally fixed by way of the closing section 44.

Pushing the partition panel 19 into the partition frame 20 braces the partition frame 20 so that it retains the form shown in FIG. 1.

FIG. 4 shows a perspective view of a supporting section 41 with the closing section 44 mounted. One can clearly recognize the joint sections 60 with their angular heads 61. The joint sections 60 are retained in the top and bottom cross bars 31 and 32 by means of their angular heads 61. The joint sections 60 are screwed to the supporting section by screws 62 so that the joint sections 60 are fixedly connected with the supporting sections 41, 42 and with the top and bottom cross bars 31, 32. For securing the screws 62 a screw hole, which may be threaded, is provided at a specified distance from the ends of the supporting sections. It is also possible to use a thread-forming screw.

The joint section 60 of FIG. 4 is shown in FIG. 5 on an enlarged scale with the hole for the screw 62 recognizable.

Alternately a joint section 60 as it is illustrated in FIG. 6 may be used. This provides a no-screw attachment. The latch joint 63 allows pushing the joint section into a matched groove in the supporting sections 41, 42 in which it latches. This again allows a firm seat so as to provide a dependable joint between the cross bars and the supporting sections.

FIG. 7 is an enlarged, perspective illustration of the rear panel 36 of the furniture unit 1. The top cross bar 31 and the bottom cross bar 32 are joined together near or at their ends by way of supporting sections 41 and 42 to form a base frame 30. Between the supporting sections 41 and 42 the rear panel 36 with the panel sections 37 is provided.

Each single panel section 37 has a cross-section as it can be seen in FIG. 8. One of the panel sections ends shows a continuous groove 39 while the other of the ends is provided with a continuous tongue 40. The groove 39 and the tongue 40 are dimensioned so that the tongue 40 of another panel section 37 precisely fits into the groove 39 of a first panel section. It can be inserted at an angle while subsequently the inserted section can be bent back to achieve straight alignment. This results in a firm seat of the rear panel 36.

Each of the panel sections 37 comprises a hollow space 49. The single panel sections may consist of a great variety of materials such as wood, plastic and metal, and in particular light metal. They may for example be of an aluminium material allowing an optically appealing design.

FIG. 9 illustrates a perspective, partially exploded, overview of a furniture unit 1. The illustration approximately corresponds to the FIG. 1. Some of the single panel sections 37 have been pulled off rearwardly from the rear panel 36. Behind the rear panel 36 an angle 73 is revealed that serves for example for securing the bottom cross bar 32 to a wall of a building.

The partition frame 20 consists of the front functional sections 5 and the rear functional sections 6, and of the top beam 21 and the bottom beam 22. The fitting sections 7 are retained at the partition frame 19 by means of pegs 9, 10.

The upper pegs 9 at the two functional sections 5 and 6 are inserted into the first groove 11. To this end the section is placed horizontal, the groove 11 facing upwardly, and placed on the pegs 9. Then the fitting section 7 is pivoted downwardly about the pivot point of the pegs 9 so that the second groove 12 bears against the second pegs 10. In this way the second pegs 10 are received in the second groove 12. The pegs 10 in the groove 12 prevent further outwardly movement while the first pegs 9 in the first groove 11 prevent inwardly movement of the fitting section 7. Furthermore the pegs 9, 10 reliably divert the forces acting from above.

Another groove 23 beneath the first and second grooves 11, 12 serves to receive a furniture element 8 configured in particular as a bottom angle or a shelf to allow attaching further components.

The partition frame 20 is supported downwardly by a base 71 on which retaining pins 35 are provided which are inserted into matching bottom apertures of the functional sections 5. A T-bar is pushed onto the partition frame 19 from the front, covering the gap between the two functional sections 5 in which the partition panel 19 has been inserted.

After inserting the partition panel 19, an adjusting unit 50 is pushed in between the partition panel 19 and the top beam 21 and latches into a recess or a notch 59 of the top beam 21.

FIG. 10 is an enlarged illustration of the fitting section 7 with the first groove 11, the second groove 12, and the further groove 23. The outer top edge 15 is rounded or stepped. The outer edge 15 shown has a radius 16 allowing free rotation of the fitting section 7 on the pegs 9 with the edge 15 of the fitting section 7 not protruding outwardly.

FIG. 11 shows the partition frame 20 comprising a top beam 21 and a bottom beam 22.

The beam 21 consists of the beam parts 26 and 27. The beam part 26 has a supporting lug 28 at its end while the beam part 27 has an engaging lug 29. At the other end of the beam parts 26 and 27 the notch 59 is provided for accommodating the adjusting unit 50.

Two functional sections 5 and two functional sections 6 and the top beam 21 and the bottom beam 22 together form the partition frame 20.

It is possible for a front functional section 5 and a rear functional section 6 and a beam part 26 and a beam part 27 to form a part frame where the single components are linked to one another in pivot points to form a four-bar mechanism. A second part frame is correspondingly formed of the same parts.

Now the part frames can be assembled to form the partition frame 20 according to FIG. 11 wherein two beam parts 26 and 27 are assembled such that one of the beam parts has the supporting lug at its front end and the other of the beam parts, the engaging lug at its front end, while the notches 59 at the other end lie parallel to one another and form in particular one shared notch 59.

This configuration allows to insert the part frame shown on the left in FIG. 11 with the engaging lug 29 from above into a slot 33 of the top cross bar. The supporting lug, which is then provided on the bottom, is supported in the slot 33 on the bottom cross bar 32. The other of the part frames presently shown on the right is preassembled identically and then rotated 180° so that the engaging lug 29 engages the slot 33 at the bottom cross bar 32 while the supporting lug 28 of the beam part 26 is supported in the slot 33 of the top cross bar 31. Such joining the two part frames in the pivot points 24 or the holes 64 allows a firm hold of the partition frame 20 at the cross bars 31 and 32. The angular shape of the engaging lugs 29 firmly retains the partition frame both in the vertical and the horizontal directions at the cross bars 31 and 32.

FIG. 12 is an enlarged illustration of the region of the adjusting unit 50 in the mounted state with the notch 59 at the top beam 21 visible.

FIG. 13 is an enlarged illustration of the adjusting unit 50, which has a long contacting leg 51 and a short contacting leg 52. The short contacting leg 52 is provided with adjusting screws 53 and 54. The adjusting screw 53 serves to adjust the height while the adjusting screw 54, being a continuous screw, relates to length adjustment.

The long contacting leg 51 is provided with a spring arm 58, which in the normal state protrudes upwardly.

When the adjusting unit 50 is pushed into the space between the partition panel 19 and the top beam 21 the spring arm 58 is first pressed downwardly until the spring arm resiliently rises in the offset 59 and is firmly wedged in the notch 59. This readily prevents the adjusting unit 50 from being pulled out.

FIG. 14 shows a much-enlarged detail of a lateral view with the region of the adjusting unit 50 in the installed state. The spring arm 58 is upwardly resiliently mounted in the notch 59 where it rests against the panel. In the case that dismantling is intended, the spring arm 58 must be pressed downwardly from the side with a tool or optionally with a finger of a hand so as to allow removal of the adjusting unit 50.

The distance of the notch 59 from the end of the beam is dimensioned such that the notch 59 is not covered by the functional section 5.

FIG. 15 shows a cross-section of the adjusting unit 50. The long contacting leg 51 of the adjusting unit 50 is provided with a slotted region 57 on which the adjusting screw 53 acts. With increasing depth of the screwed-in adjusting screw 53 the slotted region 57 expands so as to allow an adjustment of the height by means of the adjusting screw 53.

FIG. 16 shows two partition frames 20 stacked upon one another. The ends of the functional sections 5 and 6 are provided with guide holes 34 for inserting retaining pins 35 to retain a pair of functional sections 5 and a pair of functional sections 6 precisely vertically aligned.

This allows particular flexibility in the structure of the furniture units according to the invention since the height of various elements may be modified even at a later time. For example if a cabinet element is first used with a specific quantity of shelves or drawers and the height of this cabinet element is later intended to be expanded, then at least one matching part can be placed on top. Reversely it is also possible to remove various installations from one or more frame bodies and for example to use it as a higher cabinet or the like.

FIG. 17 shows a variant of a functional section 5 that is suitable for use with pulling devices 74. To this end, the functional sections may be provided with full recesses and half recesses in regular intervals serving to receive pulling devices 74 which extend across the front of the furniture unit. Half recesses at one of the ends allow particular flexibility of the structure.

The invention allows a basically unlimited expandability in height by the stacking capability. There is an increase in the functionality of the partition frame that comprises a simple, detachable bracing as a partition panel. The frame construction with detachable joint sections allows easy assembly. The slots disposed at defined lateral distances and also the modular structure of the rear panel allows realizing flexible widths.

Fixed, non-detachable connections can be dispensed with which reduces transport costs and damage in transit. Moreover, re-use and re-construction in dependence on the currently prevailing requirements is possible.

List of reference numerals:

| | |
|---|---|
| 1 | furniture unit |
| 2 | frame body |
| 3 | accommodating space |
| 4 | side panel |
| 5 | functional section |
| 6 | functional section |
| 7 | fitting section |
| 8 | furniture element |
| 9 | first peg |
| 10 | second peg |
| 11 | first groove |
| 12 | second groove |
| 13 | inner longitudinal face |
| 14 | outer longitudinal face |
| 15 | outer edge |
| 16 | radius |
| 17 | hole |
| 18 | hole |
| 19 | partition panel |
| 20 | partition frame |
| 21 | top beam |
| 22 | bottom beam |
| 23 | further groove |
| 24 | pivot point |
| 25 | four-bar mechanism |
| 26 | beam part |
| 27 | beam part |
| 28 | supporting lug |
| 29 | engaging lug |
| 30 | base frame |
| 31 | top cross bar |
| 32 | bottom cross bar |
| 33 | slot |
| 34 | guide hole |
| 35 | retaining pin |
| 36 | rear panel |
| 37 | panel section |
| 38 | panel section |
| 39 | panel section groove |
| 40 | panel section tongue |
| 41 | supporting section |
| 42 | supporting section |
| 43 | rabbet |
| 44 | closing section |
| 45 | hole |
| 46 | groove (for 60) |
| 47 | rabbet |
| 48 | groove |
| 49 | space |
| 50 | adjusting unit |
| 51 | contacting leg |
| 52 | contacting leg |
| 53 | adjusting screw |
| 54 | adjusting screw |
| 55 | height |
| 56 | depth |
| 57 | slotted region |
| 58 | spring arm |
| 59 | notch |
| 60 | joint section |
| 61 | angular head |
| 62 | screw |
| 63 | latch joint |
| 64 | hole |
| 71 | base |
| 72 | T-bar |
| 73 | angle |
| 74 | pulling device |
| 75 | joint members |

1. Furniture unit (1) comprising at least one frame body (2) that defines at least one box-shaped accommodating space (3) wherein at least one side (4) of the frame body (2) accommodates a partition frame (20) with a partition panel (19), wherein the partition panel (20) can be locked and/or aligned via at least one adjusting unit (50).

2. The furniture unit (1) according to claim 1 wherein the partition frame (20) comprises a top and a bottom beam (21, 22) and wherein the adjusting unit (50) is placed between the partition frame (20) and the top beam (21) for locking.

3. The furniture unit (1) according to claim 1 wherein the adjusting unit (50) is approximately L-shaped and comprises one long (51) and one short (52) contacting leg for the partition frame (20).

4. The furniture unit (1) according to claim 3 wherein the short one of the contacting legs (52) is provided with a pair of adjusting screws (53, 54) for aligning the partition panel (19) in two different directions.

5. The furniture unit (1) according to claim 4 wherein for adjusting the height (55) the adjusting screw (53) acts on a split region (57) of the longer contacting leg (51).

6. The furniture unit (1) according to claim 3 wherein the adjusting unit (50) comprises a spring arm (58) for latching and the spring arm (58) in particular protrudes from the long contacting leg (51).

7. The furniture unit (1) according to claim 6 wherein the spring arm (58) engages in a notch (59) of the top beam (21) in the mounted state.

8. Furniture unit (1) having at least one frame body (2) which defines at least one box-shaped accommodating space (3) and is supported by at least two cross bars (31, 32), the first of which serves as a top cross bar (31) and a second, as a bottom cross bar (32), wherein the top cross bar (31) is connected with the bottom cross bar (32) via at least one supporting section (41, 42), wherein at least one joint section (60) is provided for connecting at least one cross bar (31, 32) with at least one supporting section (41, 42), the joint section (60) having an angular head (61) that enters into the cross bar (31, 32) in the mounted state.

9. The furniture unit (1) according to claim 8 wherein at least one cross bar (31, 32) comprises at least one hole (45) for accommodating the angular head (61) of the joint section (60) wherein in particular a plurality of evenly spaced holes (45) is provided in the cross bar (31, 32) wherein in particular both the cross bars (31, 32) are identical in structure.

10. The furniture unit (1) according to claim 8 wherein the joint section (60) is connected with the supporting section (41, 42) by way of at least one screw (62).

11. The furniture unit (1) according to claim 8 wherein the joint section (60) comprises a latch joint (63) for a connection with the supporting section (41, 42).
